(19) United States
(12) Patent Application Publication
(10) Pub. No.: US 2018/0219392 A1
(43) Pub. Date: Aug. 2, 2018

(54) Charging Station for Telecommunication Devices and Electronic Watches

(71) Applicant: Klemens Dittrich, Wuppertal (DE)

(72) Inventor: Klemens Dittrich, Wuppertal (DE)

(21) Appl. No.: 15/742,592

(22) PCT Filed: Jul. 12, 2016
(86) PCT No.: PCT/DE2016/100309

§ 371 Date: Jan. 8, 2018

(30) Foreign Application Priority Data
Jul. 15, 2015 (DE) 20 2015 103 714.7
Apr. 14, 2016 (DE) 20 2016 101 967.2

(51) Int. Cl. H02J 7/00; G04G 19/00; G06F 1/16; H02J 7/02

(52) U.S. Cl. CPC H02J 7/0027; G04G 19/00; H04B 1/3827; H02J 7/0044; H02J 7/025; G06F 1/1632

(57) ABSTRACT

A charging station for telecommunication devices, electronic watches 10 and other small electronic devices comprise a platform 2 having an elongated receptacle 3, 4 underneath which supply cable 5 and plug-in connectors 6 for connection to the appropriate 8 can be laid, whereby the platform 2 is designed to hold the watches 10 in place for the charging process and temporary storage directly or by means of a watch charger 11.

The invention concerns a charging station for telecommunication devices and electronic watches.

Telecommunications devices that are familiar as Smartphones and electronic watches known as smart watches enable the user to request very different services and thus to use them practically as small computers. This means that these watches also have a relatively high energy consumption, so that the manufacturers of the watches have also created various facilities for charging them. With the Apple watch, for example, charging at the end of the day is done by placing a charging station on the reverse of the watch, so that the watch is kept ready for operation through a type of inductive charging. The connector, or the watch charger, is placed on the reverse and the exact contact is ensured by means of a magnet. A disadvantage is that a separate charger is required for each watch. Apart from the costs this causes, it is a disadvantage that, for example, in a household with five or six persons and correspondingly five or six watches as well, joint charging, for example in the evening, is not easily possible. A charging device is familiar from DE 10 2013 009 880 A1 with which telecommunication devices, Tablets and small computers can be supplied with power at the same time, but not the above-mentioned devices.

The invention is therefore based on the task of creating a charging station that is suitable in particular for charging a number of smart watches and other electronic watches at the same time.

The task is solved in accordance with the invention through a charging station for telecommunication devices, electronic watches and other small electronic devices with a platform having at least one long support under which supply cables and plug-in connectors for connecting to the relevant charger can be laid, whereby the platform is designed to fix the watches directly or through a watch charger for the charging process and temporary storage.

This means that, where necessary, a number of watches can be arranged on or in the platform that are all connected with a charger, for example a USB charger, that takes over the central task of charging. At the same time, special watch chargers tailored to the respective watches are not required, only so-called connectors, i.e. power connections for the actual watch. It is therefore extremely beneficial to charge a number of different watches at the same time, for example in the evening, with the help of a single USB charger. They are available to the users the following day without the necessity for separate connectors or similar.

In accordance with an expedient version of the invention it is planned for the watch charger to have a fitting attachment in the base that can be fixed in place in the platform's long supports. A number of this type of watch charger can be held in place on the platform in order to be able to charge several watches of this type at the same time, as described above. The watch charger with its connector sits next to other watch chargers of this type on a platform and is connected with the charger, so that it is immediately available for holding or for connecting to a watch. This applies to all adjacent watch chargers that are allocated to the platform. Quick, exact and secure connection of the watch charger with the platform is possible by means of the fitting attachments or the plug-in parts.

The exact fit of the watch charger on the platform is optimised in that the fitting attachment has magnets that are correspondingly shaped and arranged with contact magnets that are allocated to the face of one of the housings designed to hold the platform. In this way, all the watch chargers can be exactly connected to the platform in such a way that they are always correctly fitted and can be activated immediately by the user.

In order that the watch charger that is arranged on the platform next to other watch chargers can be easily accessible it is provided that the watch charger has a slanted top panel that is designed to receive the watches or hold them in place. As is known, a connector of this type works magnetically so that an exact fit of the watch in the watch charger is always guaranteed even with a more or less steep incline of the slanted top panel.

In order to guarantee exact connection of the watch charger with the platform's USB charger and to take up as little space as possible, the invention provides that the watch charger has grooves on the side opposite the magnet in the top panel of the fitting attachment for the supply cable for the charger having several plug-in connectors. The supply cable is therefore not on the top panel or the attachment or loose at the side but is firmly held in place and cannot therefore be mistaken for other cables. This makes exact positioning easy inside or at the USB charger.

Along with the use of the watch chargers with fitting attachments and fixed connections on the platform in accordance with the invention there is also the possibility of adhering them to the platform. For this purpose adhesive points are provided at one or more positions on the upper edge of the web panels that are designed to hold a watch charger in place once or repeatedly. It must be pointed out here once again that, with the term watch charger, above all the apparatus part referred to by Apple as connector is meant here. This watch charger is therefore connected detachably to the upper side of the web panels, and can therefore be used with other watch chargers arranged next to it and can be replaced where required.

Along with the two possibilities described here for equipping the platform with watch chargers or connectors, the described platforms can also be used to supply Smartphones or other electronic devices, if, as provided in the invention, adapter magnets are provided on the underside of the platform that are arranged around the holes formed in the base of the web corresponding to the adapter magnets attached to the upper side of adapters. These adapters can therefore be led from below to the platform and inserted in the holes there, whereby they are then connected automatically with the platform through the adapter magnets. The USB connectors are assigned to the part of the adapter that is inserted through the holes, so that a simple connection with a Smartphone or an Apple device is possible.

Connection or allocation of the adapters to the underside of the platform and insertion into the holes is advantaged even more in that the adapters have a plug-in part insertable into a hole on the base of the web and a side wall and a slot in the adapter base receiving and clamping the connection cable and a connector. The adapter is therefore fitted with a USB connector and the required connection cable so that exact positioning that enables a secure connection or insertion of the smartphone or watch is given with the introduction into or fixing onto the underside of the platform.

A preferred embodiment for the adapter provides that the adapter has an inner part and a detachable housing connected with this. The adapter is therefore designed having two or more parts, whereby the inner part and the housing e.g. are connected to each other via a clip mechanism and can be separated correspondingly easily.

Even a three-part adapter is realised if the adapter has a bottom panel designed as a compensating element that is connected with the housing and can be detached. An essential function is given to the foot panel, which is designed as a device to adjust the height of the adapter or to compensate its height.

With Apple devices in particular using the surface is always possible, because the web panels that limit the elongated receptacles and/or the side wall of the housing in the area and at the height of the holes in the base of the web have a cut-out. All areas of the surface of the smartphone or Apple device can be accessed securely and without problems with the fingers.

In accordance with a further embodiment it is planned that the elongated receptacles in the platform are designed to hold a wireless charger with a holder for communication devices and to connect via a cable with the charger, preferably via a USB cable and charger. In this way, the individual devices can be connected with the USB charger via the wireless charger and are inserted visibly and thus operable in the above-mentioned platform, without reason to fear that they will fall out.

Along with the possibility of using a platform with the elongated receptacles and allocating to a platform in order to conceal the cables and other components, in accordance with the invention there is also the possibility of using the platform as a panel with slots or to design it with ABS moulded parts, whereby the base of the web or slot can be closed by means of a rocking rod having notches to hold the connectors. The advantage of this is that, for example, the relevant components can be concealed underneath the panel or in it, that to access the USB connectors, which are otherwise effectively secured by the rocking rod, all that has to be done is to lift this rod.

The number of watches and communication devices as well to be allocated to a platform of this type is naturally limited. However, in order to specify a larger number of up to 24 platforms and thus over 70 devices, it is planned in accordance with the invention that one or more platforms for a variety of telecommunication devices and electronic watches are designed to be integratable and combinable with a lockable roller container or cabinet, whereby the roller container or cabinet has a fan, cable ducts and/or multiple sockets. In this way a very expedient specification is to be fulfilled without laying a large amount of cable for this purpose. On the contrary, by means of a suitable USB charger large numbers of small appliances can be supplied at the same time with the required energy and this in a transparent manner.

An alternative embodiment of the invention provides that the platform is designed as an insert with a holder for a telecommunication device. This is therefore a charging station with a single holder for just one telecommunication device. The platform is designed as an insert and after appropriate installation is inserted into the housing.

The form this actually takes is that on its upper side the holder has a collar projecting sideways and surrounding the holder and lying with its underside on the wall of the housing.

The suggestion that the holder has reinforcing and/or spacer ribs on its outer side is intended for additional stabilisation of the insert in the holder. These ribs extend preferably in a vertical direction around the body of the holder.

A further advantageous embodiment of the invention refers to the fact that the holder is designed to be detachably connected with the adapter by means of clip mechanisms provided on its underside. As an alternative to the magnetic solutions described above, the holder can be connected with the adapter by means of clip mechanisms, whereby this solution is practical for charging stations with one and with several holders. Expediently, the clip mechanisms are located on the narrow front sides of the adapter or are positioned on the corresponding places on the holders.

The invention is distinguished in particular by the fact that a single charging station is created for one or more telecommunication devices, e.g. for Smartphones or Tablets and for electronic watches, which can be used at the same time for this type of appliance. For this purpose practically only a specific platform with one or more elongated receptacles is required to which a USB charger is allocated that is equipped with a number of terminals. so that energy consumers of any type can be connected by means of corresponding watch chargers and also USB connectors, in order to supply them with the required energy and data. Together with the simple structure, it is particularly advantageous that a secure fit is guaranteed for the devices that are to be connected to the platform, so that the valuable individual devices are not at risk through falling out or similar.

Additional details and advantages of the object of the invention can be seen in the following description of the relevant drawing, in which a preferred embodiment is illustrated with the necessary details and individual parts.

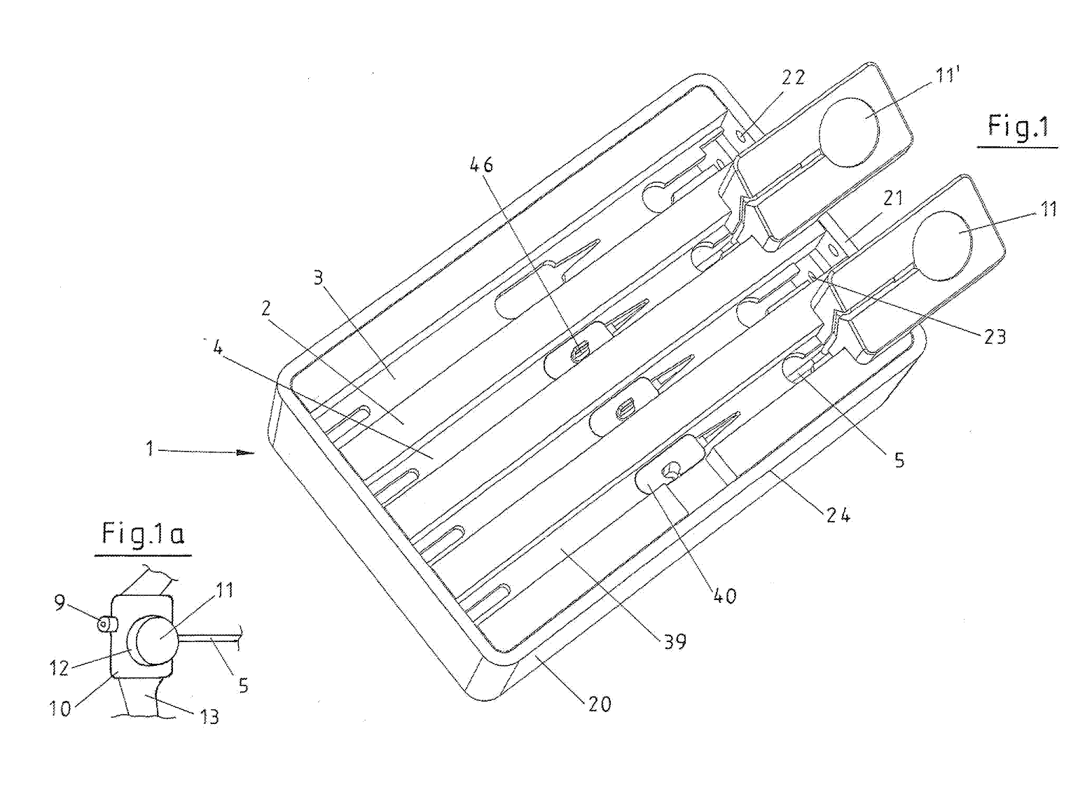

FIG. 1 shows a perspective top view of a platform with several plug-in watch chargers,

FIG. 1a shows a watch with connector or watch charger,

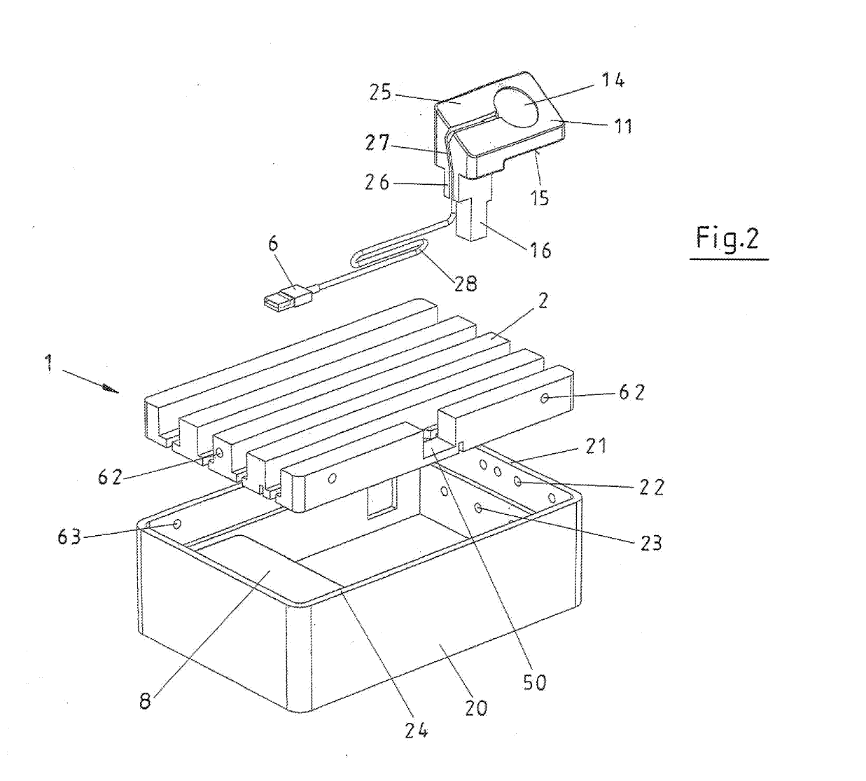

FIG. 2 shows the charging station that can be seen in FIG. 1 with details,

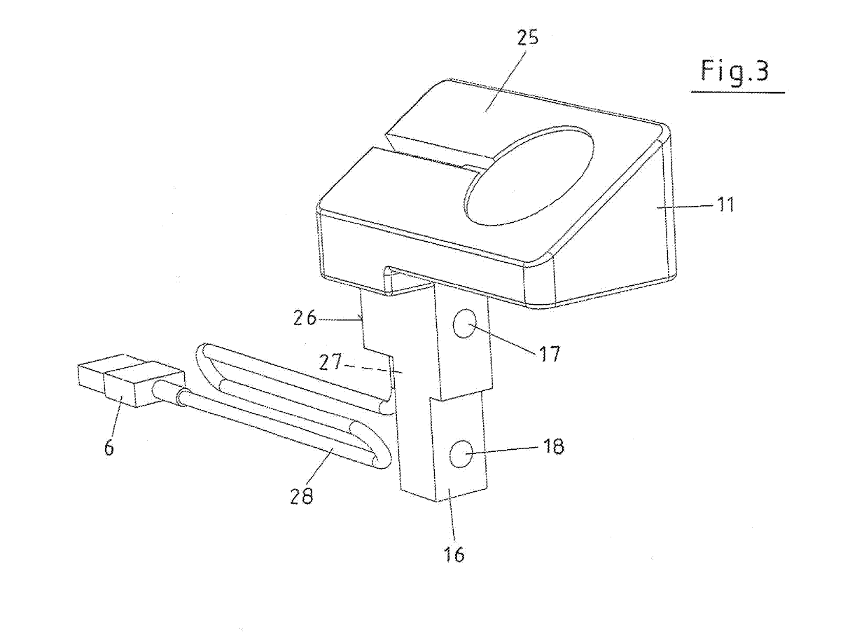

FIG. 3 shows a side view of a watch charger,

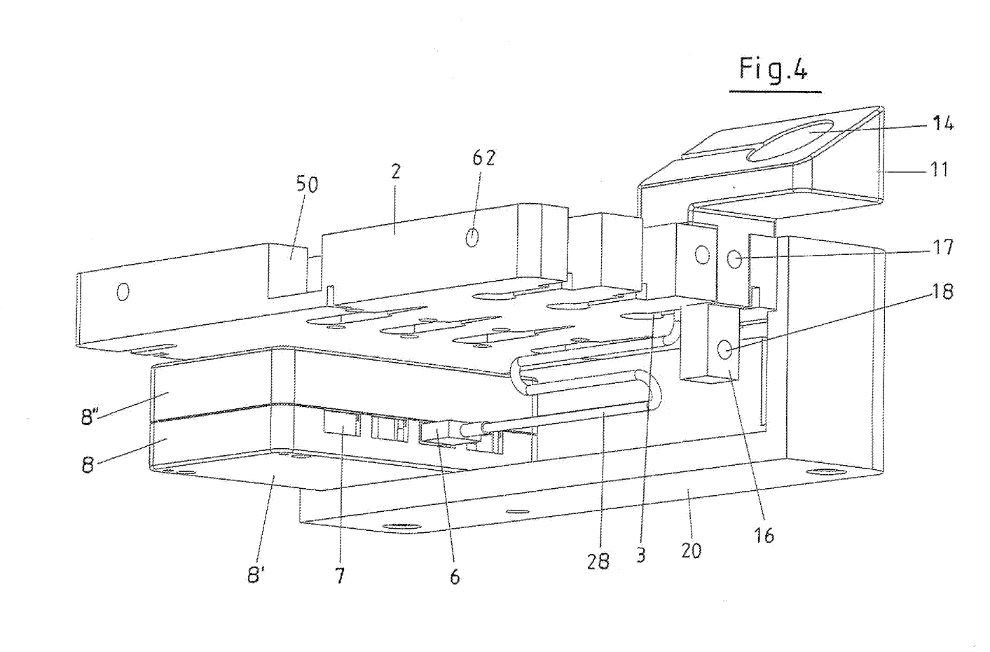

FIG. 4 shows the watch charger connected with the platform with a USB charger arranged underneath the panel,

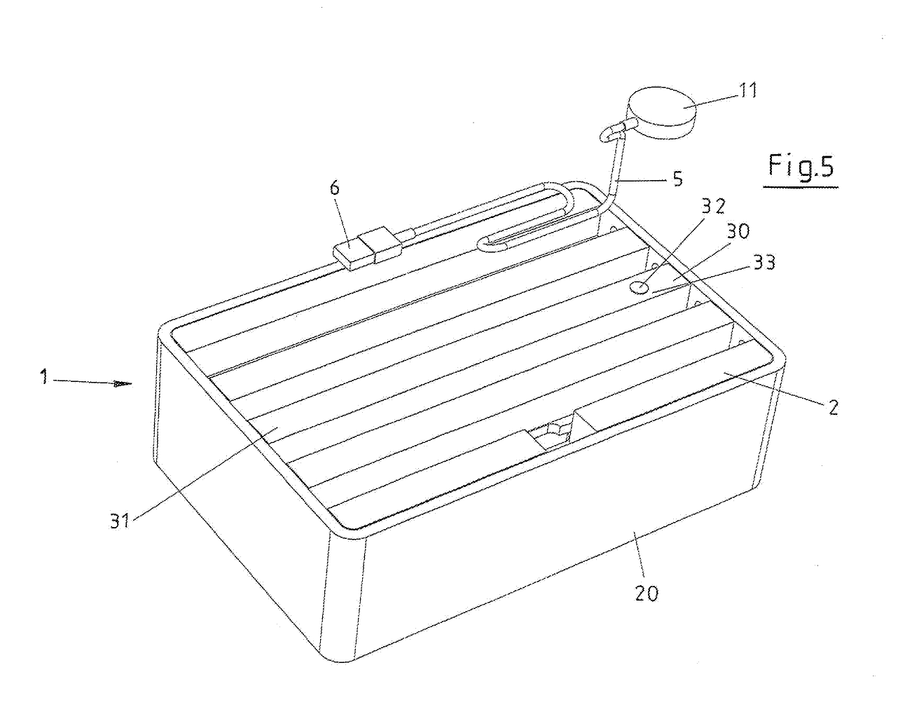

FIG. 5 shows a charging station with an adhesive watch charger for a Smartwatch,

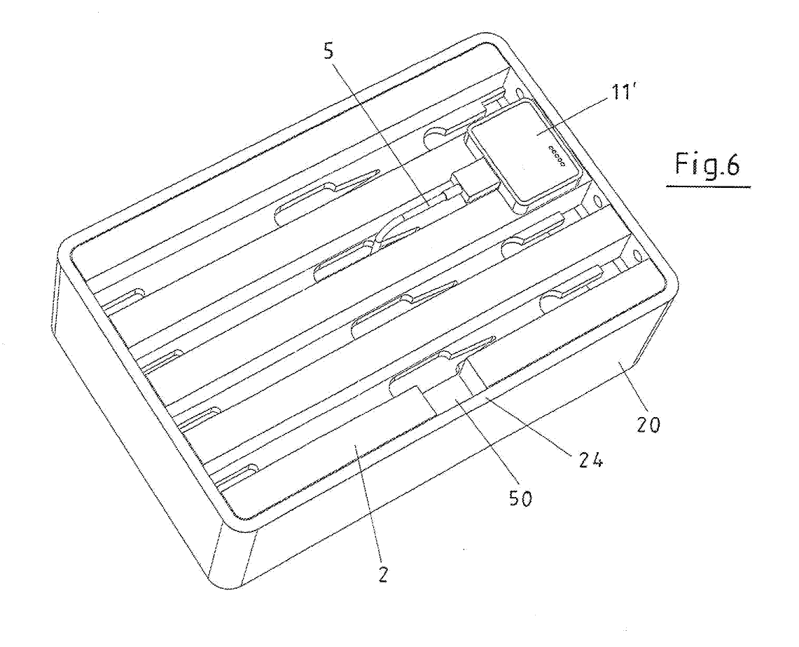

FIG. 6 shows a charging station with an adhesive watch charger for a Smartwatch,

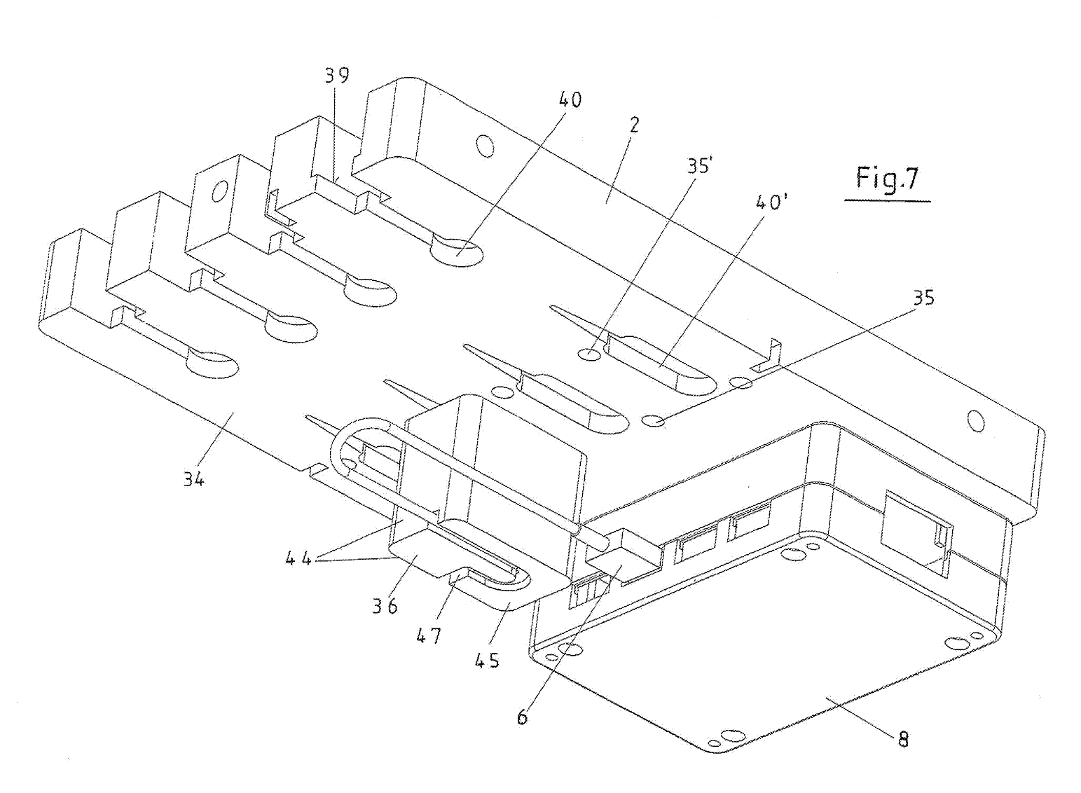

FIG. 7 shows a base view of a platform with an additional charging facility for, e.g., Smartphones,

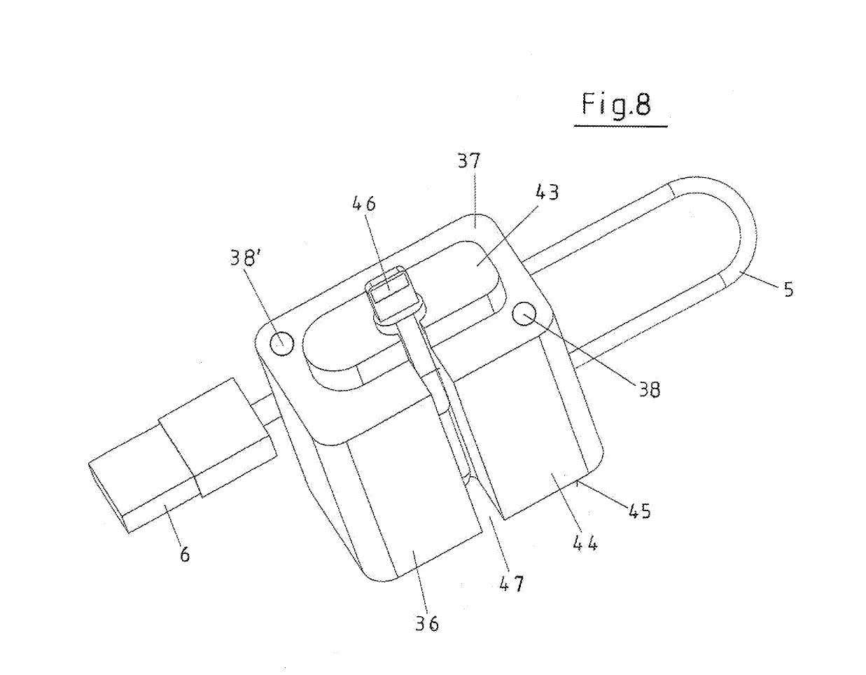

FIG. 8 shows an adapter provided for supplying Smartphones in accordance with FIG. 7,

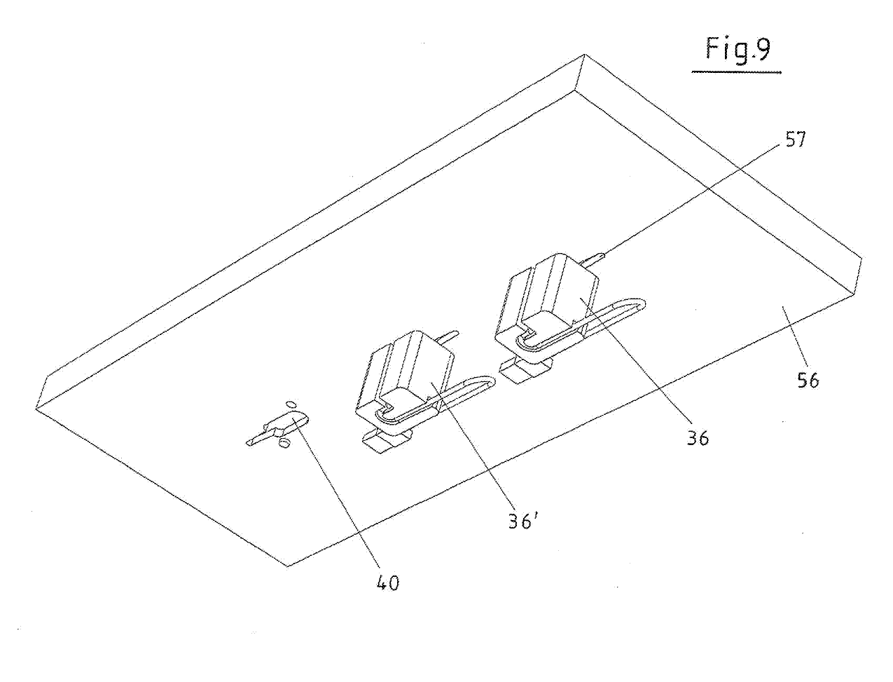

FIG. 9 shows the layout of several such adapters underneath a panel,

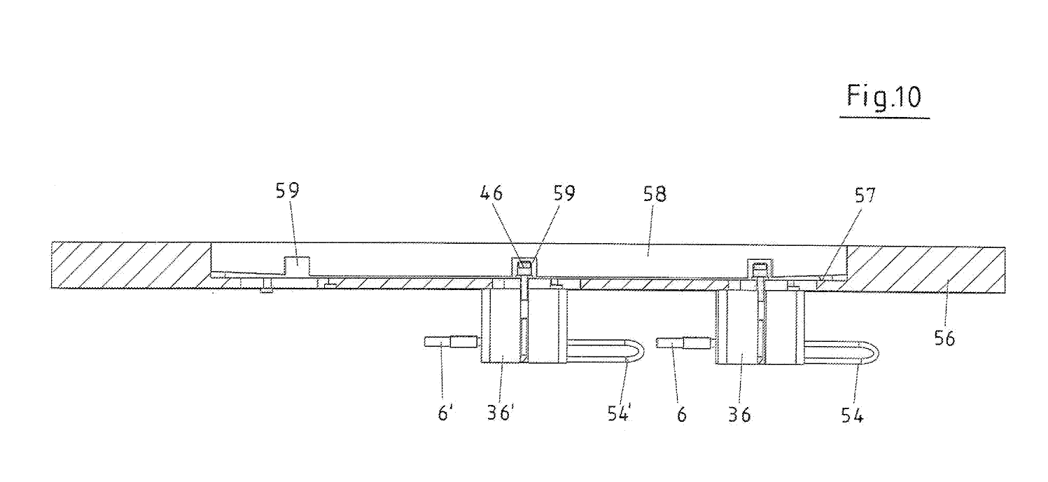

FIG. 10 shows a side view of the panel with adapters and a securing rod,

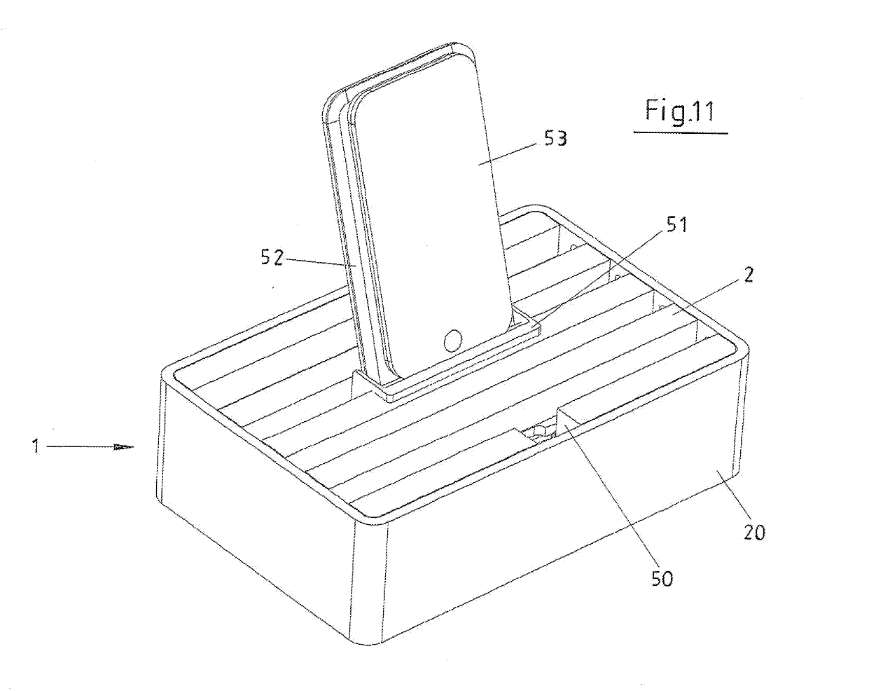

FIG. 11 shows a platform of a charging station with an attached iPhone,

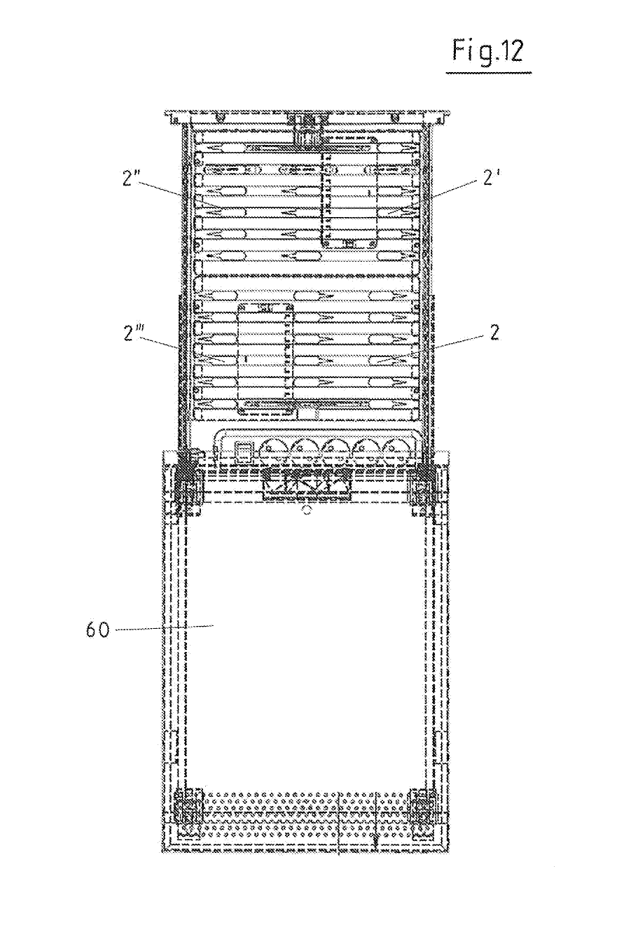

FIG. 12 shows a roller container for a variety of charging stations for a large number of watches and phones,

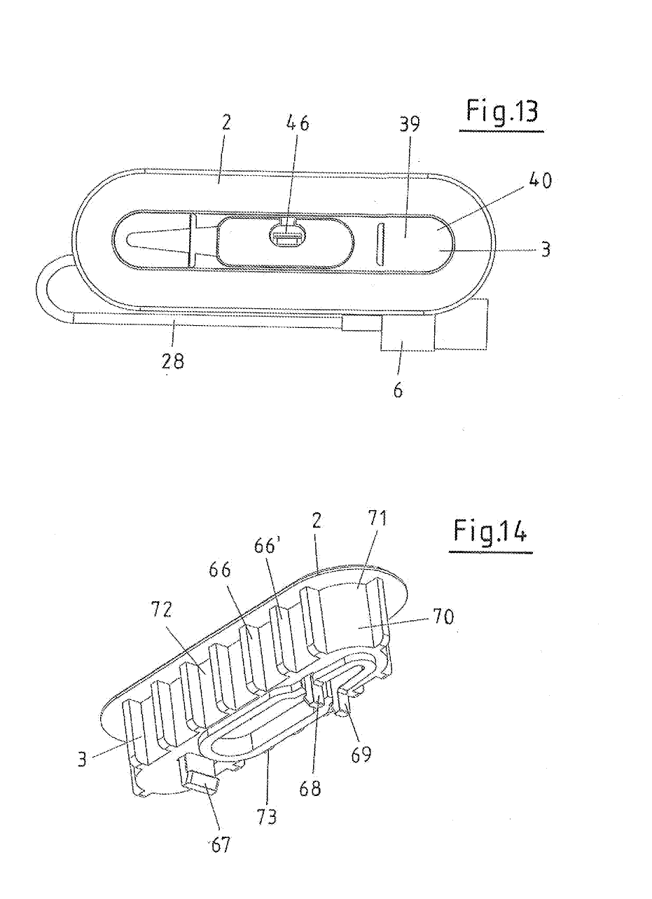

FIG. 13 shows a holder from the top,

FIG. 14 shows a holder without adapters in perspective,

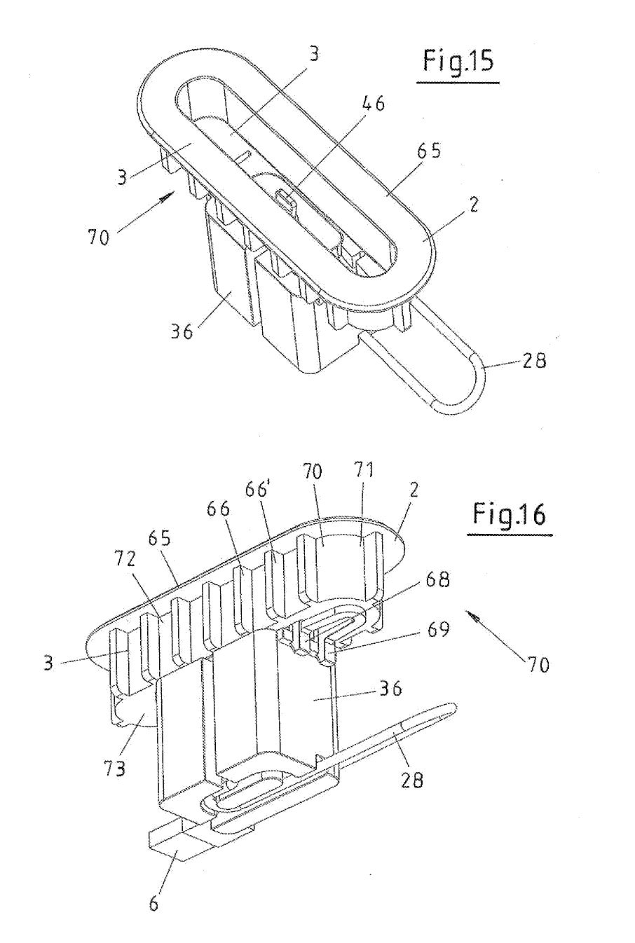

FIG. 15 shows a holder with adapters in perspective from above,

FIG. 16 shows a holder with adapters in perspective from below

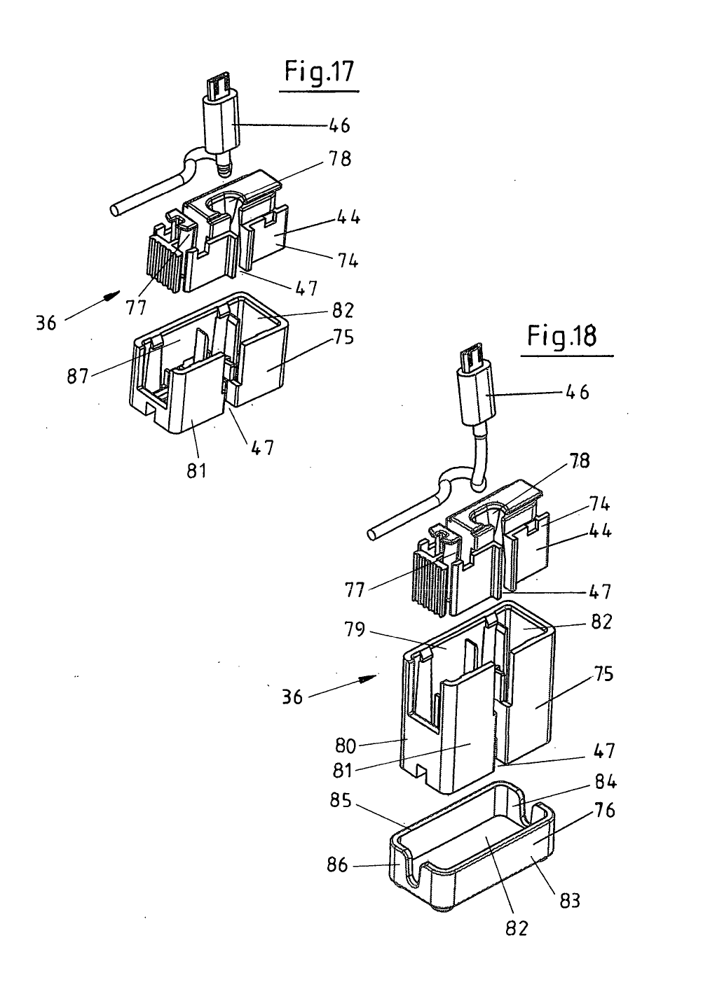

FIG. 17 shows an adapter with housing and

FIG. 18 shows an adapter with housing and base panel.

FIG. 1 shows a charging station 1 with a platform 2 having several elongated receptacles 3, 4. These elongated receptacles 3, 4 are equipped with watch chargers 11, 11′ that can be connected via their supply cable 5 and plug-in connectors 6 that cannot be seen here with a USB charger 8 located under the platform 2. In this way, two, but effectively four or more, electronic watches can be supplied with the necessary energy, whereby the USB charger 8 has a corresponding number of lead ins 7 for the plug-in connectors 6.

At a distance to the elongated receptacles 3 USB connectors 46 can be seen in the grooves, which can be utilised to hold Smartphones or similar devices or corresponding wireless chargers, in order to provide other extremely different electronic devices with energy at the same as the watches 10.

FIG. 1a shows a Smartwatch 10 having a pin 9 at the side that can be used to make various adjustments to the device. The reverse of the Smartwatch can be seen here, where a contact surface 12 is provided to hold watch chargers or so-called connectors 11. Magnets attached here ensure that secure placing of the watch charger or connectors is always guaranteed. No 13 shows the strap, which identifies the watch in this case as a wristwatch. The bases of the webs 39 have holes 40 into which adapters can be inserted from underneath, in order to make the USB connectors 46 easily and safely accessible. The platform 2 having these elongated receptacles 3, 4 and also the webs and the bases of the webs 39 is located in a housing 20, in order to secure the attached USB charger 8 as well and to conceal the required cable connections and to house them securely.

FIG. 2 makes clear that the platform 2 is inserted into housing 20 and how this is done. Housing magnets 63 are arranged on the side wall 24 and also on the other walls that correspond to the panel magnets 62, in order in this way to ensure an exact and secure fit of platform 2 in housing 20 at all times. In addition, a series of contact magnets 22, 23 are attached to face wall 21 that act together with the magnets 17, 18 attached to the fitting attachment 16 of the watch charger 11, in order to ensure a secure fit of the fitting attachment 16 in the housing 20 or of the watch charger 11 in the elongated receptacles 3, 4. As can be seen from FIG. 3, the allocated sides of the fitting attachment 16 have magnets 17, 18, while the opposite side 26 has notches 27, which can be seen again in FIG. 2, in order to accommodate the supply cables 28 securely and to make fitting easier. The top panel 25 of the watch charger 11 is slanted and has a holder or an insertion opening 14 into which a connector or similar or the watch itself can be inserted directly, in order to supply it with energy. This specially designed fitting attachment 16 is attached to the bottom 15 of the watch charger 11 and as already mentioned ensures a permanent secure fit of the watch charger 11 in the platform 2.

FIG. 4 shows a fitting attachment 16 of a watch charger 11 inserted into an elongated recess 3. The two magnets 17, 18 are visible here that are arranged offset in accordance with the end wall 21 of the housing 20. The inclined top panel 25, into whose insertion opening 14 a watch can be inserted, is also visible here. This insertion opening 14 acts here practically as a connector.

It can also be seen in FIG. 4 that the USB charger 8, which consists of two housing parts 8′, 8″, is located underneath platform 2. A variety of entrances 7 for the plug-in connectors 6 is provided in the bottom part of this USB charger 8′. A plug-in connector 6 is shown inserted into an entrance 7. The supply cable 28 runs in given slight curves and inside the head of the watch charger 11 in the above-mentioned notches 27.

Along with the connection of the watch charger 11 with the platform 2 shown as an example in FIG. 4 there is an additional possibility for fixing the required connectors onto the web panels 30 or their upper edge 31 by means of adhesive points 32. FIG. 5 and FIG. 6 show this, whereby FIG. 5 represents a connector for an Apple device, while in FIG. 6 a Smartwatch connection part is shown and given the reference number 11′. In the outer panel web 30 a cutout 50 is shown through which the various surfaces of the Apple devices can be easily accessed, for example with a finger.

The positions 33 at which the adhesive points 32 are provided are predetermined and designed so that the supply cable 5 can be led easily through the holes 40 to the underside 34 of the platform 2.

As already mentioned above, on the underside 34 of the platform 2 there are a variety of inlets provided for plug-in connectors 6 and associated with the USB charger 8. Along with the holes 40 for the fitting attachments 16 of the watch chargers 11, holes 40′ are provided in the web base 39, in order to be able to attach the adapter 36 represented in FIG. 7 to the underside 34 of platform 2. For this purpose the underside 34 has adapter magnets 35 that correspond to the adapter magnets 38 that are assigned to the upper side 37 of the adapter 36. The last mentioned can be seen in FIG. 8, whereby it is also clear that the upper part of the adapter 36 is fitted with a plug-in part 43 that can be inserted into the corresponding holes 40′. A USB connector 46, whose supply cable is embedded in a slot in the adapter base 45 or in the side wall 44, projects beyond this plug-in part 43. This ensures secure mounting and a secure fit in particular of the USB connector 46. The adapter magnets are numbered 38 and 38′.

Instead of using a platform 2 it is possible to employ a panel 56 in which there are slots, in order, as indicated in FIG. 9, to fasten the individual adapters 36, 36′ by means of the adapter magnets that cannot be seen here. On the other side of the panel 56 the slot 57 can be seen in which a rod 58 is mounted rocking in order to be able to secure the projecting USB connectors 46. For this purpose, there are notches 59 in the rocker rod 58 that, as can be seen in FIG. 10, cover the USB connectors 46. The rocking design provides the possibility of removing the rod 58 and thus connecting the adapters 36 or the USB connectors 46 with the respective devices that are to be charged.

The other devices that are to be charged that were already mentioned can be fitted to the platform 2 by means of wireless chargers 51 as well, as shown in FIG. 11, whereby a secure fit of the phone 53 is ensured by means of a holder 52. The holder 52 or the wireless charger 51 can be connected with USB cable 54, which is not shown here, with USB charger 8, which is not shown here.

A large number of phones and watches of this type can be supplied at the same time with the necessary energy, if suitably designed platforms 2, 2′, 2″, 2′″ are accommodated in a roller container 60. Along with the variety of platforms 2 of this type, it is also an advantage that the complete supply is possible using one or a few USB chargers 8 and in such a way that unauthorised persons cannot access the individual devices during the charging period, so that for example at the start of the work process recharged devices are available for all users.

FIG. 13 shows the variant of the invention with a holder 3 for a single telecommunication device that is not represented here. The holder 3 comprises a horizontally positioned collar 65, which is designed oval in the broadest sense, that serves as a support for the insert 70. The USB plug numbered 46 that provides the connection between the telecommunication device and the adapter 36 or the cable 28 can be seen in the holder 3.

Reinforcement and/or spacer ribs, two of which are shown as examples numbered 66, 66′, which are positioned underneath the collar 65 that acts as a support, can be clearly seen in FIG. 14. The ribs 66, 66′ on the outside 72 of the holder 3 extend in a vertical direction and for the insert 70 facilitate the fit in the housing that is not shown here in interplay with the collar 65 on the top 71 of the holder 3. On the underside 73 of the holder 3 in this embodiment there are three clip mechanisms 67, 68, 69, by means of which a detachable connection is possible between the insert 70 and the adapter that is not shown in FIG. 14. The clip mechanisms 67, 68, 69 are as it were positioned around the opening 39 in the web base 40 on its long sides.

This is then illustrated by FIG. 15, in which the insert 70 and adapter 36 are connected with each other, so that the telecommunication device that is not shown here can be connected using the stick 46.

Finally, FIG. 16 shows the unit consisting of insert 70 and adapter 36 from an angle below with the now engaged clip mechanisms 68, 69 on the underside 73 of the holder 3.

FIG. 17 shows an adapter 36 in the two-part variant for the USB or other 46 with the corresponding holder 78. The adapter 36 has an inner part 74 and an outer part 75 in the shape of a housing that are connected to each other through the clip mechanism, so that the connection can be disengaged by actuating the handle 77. The housing 75 comprises the walls 81, 82 and 87 and has the slot 47′, which corresponds to the slot 47 of the inner part 74.

Along with the two parts 74 and 75 the variant shown in FIG. 18 with a three-part adapter 36 has a base panel 76 that is used to adjust or adapt the height of the adapter 36. Along with a bottom panel 82, the base panel 76 has four walls 83, 84, 85 and 86, while the housing 75 comprises four walls 79, 80, 81 and 82.

All the named characteristics, including those that can be seen solely in the drawings, are regarded alone and in combination as integral to the invention.

1. Charging station for telecommunication devices, electronic watches (10) and other small electronic devices with a platform (2) having at least one elongated receptacle (3, 4) under which a supply cable (5) and plug-in connectors (6) for connections to the appropriate charger (8) can be laid, whereby the platform (2) is designed to fix the watches (10) in place for the charging procedure and temporary storage directly or by means of a watch charger (11), wherein the adapter (36) has a support (47) holding and clamping the connection cable (5) and a connector (46) in a plug-in part (43) insertable in a hole (40) in the web base (39) and a side wall (44) or in the adapter bottom (45).

2. Charging station in accordance with claim 1, that wherein the watch charger (11) has a fitting attachment (16) on the floor (15) that can be set into the elongated receptacles (3, 4) on the platform (2).

3. Charging station in accordance with claim 2, wherein the fitting attachment (16) has magnets (17, 18) that are shaped and arranged corresponding to contact magnets (22, 23) that are assigned to the end wall (21) of a housing (20) designed to hold the platform (2).

4. Charging station in accordance with claim 2, wherein the watch charger (11) has a slanted top panel (25) that is designed to hold or fix the watches (10) in place.

5. Charging station in accordance with claim 3, wherein the watch charger (11) has notches (27) on the side (26) opposite the magnets (17, 18) for the supply cable (5) leading to the charger (8) holding several plug-in connectors (6) in the top panel (25) and the fitting attachment (16).

6. Charging station in accordance with claim 1, wherein adhesive points (32) are provided at one or more points (33) on the upper edge (31) of the web panels (30) that are designed to hold the watch charger (11) in place once or repeatedly.

7. Charging station in accordance with claim 1, wherein adapter magnets (35) are provided on the underside (34) of the platform (2) that are arranged around holes (40) shaped in the web base (39), corresponding with adapter magnets (38) located on the top (37) of adapters (36).

8. (canceled)

9. Charging station in accordance with claim 1, wherein the adapter (36) has an inner part (74) and a detachable housing (75) connected with this.

10. Charging station in accordance with claim 9, wherein the adapter (36) has a base panel (76) designed as a detachable compensating element that is connected with the housing (75).

11. Charging station in accordance with claim 2, wherein the web panels (30) limit the elongated receptacles (3, 4), and/or the side wall (24) of the housings (20) has a cut-out (50) in the area and at the height of the holes (40) in the web base (39).

12. Charging station in accordance with claim 1, wherein the elongated receptacles (3, 4) are designed to hold a wireless charger (51) with a holder (52) for phones (53) in the platform (2) and connecting by means of a cable (54) with the charger (8).

13. Charging station in accordance with claim 1, wherein the platform (2) is designed as a panel (56) with slots (57) or ABS moulded parts, whereby the web base (39) can be closed by means of a rocker rod (58) having notches (59) that receive the connectors (46).

14. Charging station in accordance with claim 1, wherein one or more platforms (2) for a variety of telecommunication devices (53) and watches (10) are designed to be integratable and combinable with a lockable roller container (60) or cabinet, whereby the roller container (60) or cabinet has a fan, cable ducts and/or multiple sockets.

15. Charging station in accordance with claim 1, wherein the platform (2) is designed as an insert (70) with a holder (3) for a telecommunication device.

16. Charging station in accordance with claim 1, wherein the holder (3) has a collar (65) on its top (71) that surrounds the holder (3) and projects laterally.

17. Charging station in accordance with claim 1, wherein the holder (3) has reinforcement and/or spacer ribs (66) an its outer side (72).

18. Charging station in accordance with claim 1, wherein the holder (3) is designed with detachable clip mechanisms (67, 68, 69) provided on its underside (73) that can be connected with the adapter (36).
